(19) United States
(12) Patent Application Publication
(10) Pub. No.: US 2026/0172490 A1
(43) Pub. Date: Jun. 18, 2026

(54) DEVICE AND METHOD FOR PROCESSING DATA UNITS, IN PARTICULAR IN AN AUTOMOTIVE NETWORK

(71) Applicant: Robert Bosch GmbH, Stuttgart (DE)

(72) Inventors: Filip Moerman, Tourrettes sur Loup (FR); Herbert Leuwer, Langballig (DE); Thomas Wollenhaupt, Backnang (DE)

(21) Appl. No.: 19/410,515

(22) Filed: Dec. 5, 2025

(30) Foreign Application Priority Data
Dec. 17, 2024 (DE) 10 2024 212 023.5

(51) Int. Cl. H04L 69/22

(52) U.S. Cl. CPC H04L 69/22

(57) ABSTRACT

A method and device for processing data units. The device includes an input interface to receive segments of a first data unit, an output interface to transmit a first data container, a circuit for collecting the segments of the first data unit in the first data container, and a first transmitter receives the first data container from the output interface and transmits the first data container. The circuit includes a memory. The circuit stores the first data container in the memory. The first transmitter includes a memory for storing the first data container. The input interface transmits a second data container. The circuit collects the segments of the second data unit in the second data container. The device includes a second transmitter for receiving the second data container from the output interface and for transmitting the second data container. The circuit stores the second data container in the memory.

### FIELD

The invention relates to a device and a method for processing data units, particularly in an automotive network.

### BACKGROUND INFORMATION

Communication in a CAN-, LIN-or AUTOSAR-based automotive network requires the routing of packets in software systems.

Routing in the automotive network presents challenges due to the use of many different protocols, different data rates, different latency requirements and/or different QoS requirements in the automotive network.

Routing the packets requires multiplexing. Multiplexing is performed by various software modules of the software system.

Unavoidable context switching times for multiplexing the packets in the software systems significantly limit the achievable event rates that are critical for real-time performance.

In many cases, a main CPU embedded microcontroller performs the multiplexing. In some cases, dedicated microprocessor cores are used to perform multiplexing.

### SUMMARY

The device for processing data units, in particular in an automotive network, according to the present disclosure implements multiplexing entirely in hardware.

According to an example embodiment, the device comprises an input interface that is designed to receive segments of a first data unit, an output interface that is designed to transmit a first data container, a circuit for collecting the segments of the first data unit in the first data container, and a first transmitter for receiving the first data container from the output interface and for transmitting the first data container, wherein the circuit comprises a memory, wherein the circuit is designed to store the first data container in the memory, and wherein the first transmitter comprises a memory for storing the first data container, wherein the input interface is designed to receive segments of a second data unit, wherein the output interface is designed to transmit a second data container, wherein the circuit is designed for collecting the segments of the second data unit in the second data container, and wherein the device comprises a second transmitter for receiving the second data container from the output interface and for transmitting the second data container, wherein the circuit is designed to store the second data container in the memory, and wherein the second transmitter comprises a memory for storing the second data container. The device comprises an input interface that is designed to receive data units and a plurality of transmitters that are designed to transmit data containers. The device comprises the circuitry for collecting the data units in the respective data containers. The circuit comprises the memory for storing the data containers that are being assembled.

The transmitters only comprise storage for the data container to be transmitted by the particular transmitter. The data containers that are currently being assembled remain in the memory of the circuit. The memory in the transmitters requires storage for only one data container in each case.

The input interface can be designed to receive data units using different protocols. The transmitters can be designed to transmit the data containers using different protocols. According to one example, the first data unit is formatted according to a first protocol, wherein the circuit is designed to recognize that the segments of the first data unit are formatted according to the first protocol, and to collect the segments of the first data unit in the first data container upon recognizing that the segments of the first data unit are formatted according to the first protocol. According to one example, the second data unit is formatted according to a second protocol, wherein the circuit is designed to recognize that the segments of the second data unit are formatted according to the second protocol, and to collect the segments of the second data unit in the second data container upon recognizing that the segments of the second data unit are formatted according to the second protocol.

The first transmitter can be designed to provide a first socket for transmitting the first data container, wherein the first data unit is assigned to the first socket, wherein the circuit is designed to recognize that the first data unit is assigned to the first socket and, upon recognizing that the first data unit is assigned to the first socket, to schedule the first data container for the first socket. The first socket can be identified by a socket identifier. The first data unit can be assigned to the first socket by means of a socket identifier. The scheduler can be designed to schedule the first data container on the basis of the socket identifier for the first socket. The socket identifier can be provided to the scheduler as metadata. The circuit can be designed to determine and/or process the socket identifier or metadata. The circuit can be designed to provide the scheduler with the first data unit assigned to the socket identifier or metadata. According to one example, the first socket is assigned to at most one data container that is being assembled.

The input interface can be designed to receive the segments of the first data unit in sequential order, wherein the circuit is designed to recognize the first segment in sequential order as the first segment of the first data container, to allocate the memory for the first data container segment by segment in the memory upon recognizing the first segment, and to store the first segment in the memory as the first segment of the first data container. By allocation of the memory, the first data container is opened for storing the first segment.

The input interface can be designed to receive segments of a last data unit in sequential order, wherein the circuit is designed to recognize the last segment in sequential order as the last segment of the last data container, and upon recognizing the last segment, to store the last segment as the last segment of the last data container in the memory, to schedule the first data container for the first transmitter and to release the memory for the first data container in the memory. The first data container is closed upon a detection that the last segment of the last data unit has been stored in the first data container. Scheduling the first data container for the first transmitter comprises copying the first data container from the memory to the memory of the first transmitter. Releasing the memory for the first data container in the memory makes the memory available for another data container.

The first data container can be closed due to various conditions:

The circuit can be designed to recognize that a condition for closing the first data container is met, and upon recognizing that the condition for closing the first data container is met, to schedule the first data container for the first transmitter and to release the memory for the first data container in the memory.

The circuit can be designed to determine the number of bytes accumulated in the first data container and to recognize that the condition for closing the first data container is met if the number of bytes reaches or exceeds a specified number of bytes. The prespecified number of bytes corresponds to a first threshold value.

The circuit can be designed to collect data units comprising the first data unit in the first data container, to exclude a last of the collected data units from the first data container upon recognizing that the condition for closing the first data container is met, and the last of the collected data units does not fit into the first data container, to open another data container for the first transmitter and to store the data unit excluded from the first data container in the other data container.

The circuit can be designed to recognize that the condition for closing the first data container is met upon reception of a segment of a data unit, wherein the data unit is a data unit that triggers the closing.

The circuit can be designed to determine whether or not the segment is the last segment of the first data unit, and to wait until the last segment of the first data unit is received, and to recognize that the condition for closing the first data container is met upon reception of the last segment of the first data unit.

The circuit can be designed to start a time or cycle counter upon an opening of the first data container, and to recognize that the condition for closing the first data container is met if the counter exceeds a limit value.

The circuit can be designed to wait until the first data container comprises a last segment of a last data unit for the first data container, and to recognize that the condition for closing is met upon recognizing that the first data container comprises the last segment of the last data unit, or that the circuit can be designed to wait until the first data container comprises the last segment of the last data unit, and to recognize a first segment of a next data unit, and to remove the segments of the last data unit from the first data container.

The circuit can be designed to recognize an error in a segment of the first data unit and to remove the first data unit from the first data container upon recognizing the error.

According to an example embodiment of the disclosure, a method for processing data units, particularly in an automotive network, comprises receiving segments of a first data unit via an input interface, transmitting a first data container via an output interface, collecting the segments of the first data unit in the first data container by using a circuit, receiving the first data container from the output interface by a first transmitter, transmitting the first data container by using the first transmitter, wherein the circuit comprises a memory, storing the first data container in the memory by using the circuit, wherein the first transmitter comprises a memory for storing the first data container, receiving segments of a second data unit via the input interface, transmitting a second data container to the output interface, collecting the segments of the second data unit in the second data container by using the circuit, receiving the second data container from the output interface by a second transmitter, transmitting the second data container by using the second transmitter, and storing the second data container in the memory by using the circuit, wherein the second transmitter comprises a memory for storing the second data container.

The method can comprise collecting the first data unit and at least one further data unit in the first container and/or collecting the second data unit and at least one further data unit in the first container.

Further exemplary embodiments can be found in the description below and in the figures.

### BRIEF DESCRIPTION OF THE DRAWINGS

FIG. 1 schematically shows a device for processing data units, particularly in an automotive network, according to an example embodiment.

FIG. 2 schematically shows the processing of the data units, according to an example embodiment.

FIG. 3 schematically shows a part of the device, according to an example embodiment.

FIG. 4 is a flowchart that comprises steps of a method for processing the data units, according to an example embodiment.

FIG. 5 shows a state machine for segment processing, according to an example embodiment.

FIG. 6 shows a state machine for overflow treatment, according to an example embodiment.

FIG. 7 shows a state machine for error handling, according to an example embodiment.

FIG. 8 shows a state machine for time processing, according to an example embodiment.

### DETAILED DESCRIPTION OF EXAMPLE EMBODIMENTS

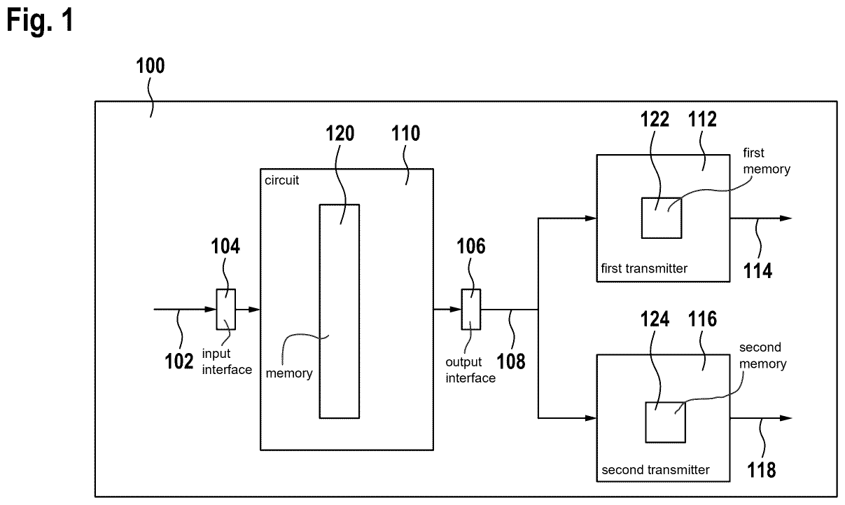

FIG. 1 schematically shows a device 100 for processing data units 102, in particular in an automotive network.

The data units 102 can be formatted according to different protocols.

The data units 102 comprise segments. According to the example, segments belonging to the same data unit 102 come in the correct order, and segments belonging to different data units 102 are not nested.

The device 100 comprises an input interface 104. The input interface 104 is designed to receive the segments of the data units 102.

The device 100 comprises an output interface 106. The output interface 106 is designed to transmit data containers 108.

The device 100 comprises a circuit 110. The circuit 110 is designed to determine the data containers 108 according to the segments of the data units 102. In this context, circuit refers to an electrical circuit. The electrical circuit can comprise one or more microprocessors. The electrical circuit can comprise firmware or software for operating the electrical circuit. The electrical circuit can comprise one system on a chip or a plurality of systems on a chip.

The device 100 comprises a first transmitter 112. The first transmitter 112 is designed to transmit frames 114 according to a first protocol. The device 100 comprises a second transmitter 116. The second transmitter 116 is designed to transmit frames 118 according to a second protocol. The first protocol and the second protocol differ from one another. The first protocol is, for example, one from a controller area network (CAN) protocol, a local interconnect network (LIN) protocol, or an Ethernet protocol. The second protocol is, for example, another one from a controller area network (CAN) protocol, a local interconnect network (LIN) protocol, or an Ethernet protocol.

The circuit 110 comprises a memory 120. The memory 120 is designed to store data containers that are being assembled.

The first transmitter 112 is designed to provide a first socket for transmitting data containers according to the first protocol. The first transmitter 112 comprises a first memory 122. The first memory 122 is designed to store a data container according to the first protocol.

The second transmitter 114 is designed to provide a second socket for transmitting data containers according to the second protocol. The second transmitter 114 comprises a second memory 124. The second memory 124 is designed to store a data container according to the second protocol.

The device 100 is not limited to two transmitters. The device can comprise a plurality of transmitters. The device 100 is not limited to two protocols. The device can be designed to transmit frames according to a plurality of protocols.

The data units 102 can be formatted differently. A data unit 102 can be formatted, for example, according to the controller area network (CAN) protocol, the local interconnect network (LIN) protocol, or the Ethernet protocol.

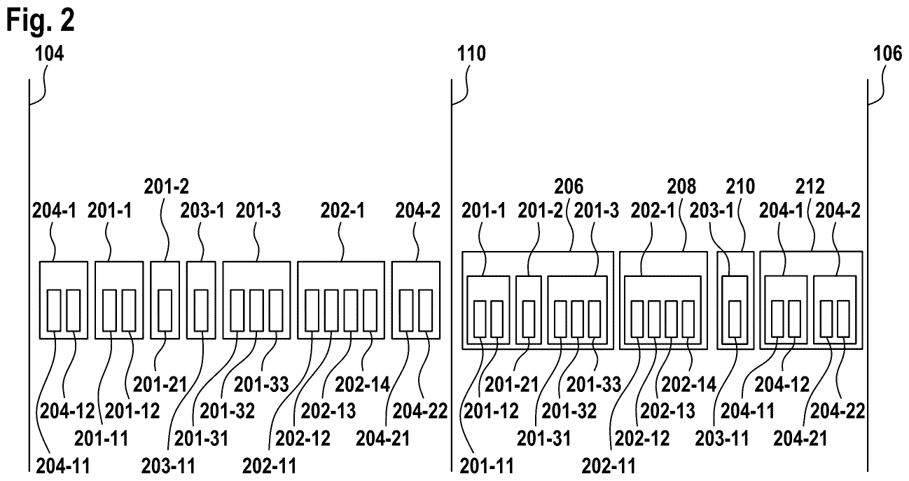

FIG. 2 schematically shows the processing of the data units 102.

According to one example, the input interface 104 receives, in one slot, a plurality of data units 201-1, 201-2 and 201-3, 202-1, 203-1, 204-1, and 204-2. The data units can be formatted according to different protocols. Some or all data units can be formatted according to the same protocol.

The data unit 201-1 comprises two segments 201-11 and 201-12. The data unit 201-2 comprises one segment 201-21. The data unit 201-3 comprises three segments: 201-31, 201-32 and 201-33. The data unit 202-1 comprises four segments: 202-11, 202-12, 202-13, 202-14. Data unit 203-1 comprises segment 203-11. The data unit 204-1 comprises two segments 204-11 and 204-12. The data unit 204-2 comprises two segments 202-21 and 202-22.

The data units are received by the input interface 104 in the order 204-1, 201-1, 201-2, 203-1, 201-3, 202-1, 204-2.

The output interface 106 transmits, in a later slot, a data container 206 according to the first protocol, a data container 208 according to the second protocol, a data container 210 according to the third protocol and a data container 212 according to the fourth protocol.

The data container 206 according to the first protocol comprises the three data units 201-1, 201-2 and 201-3.

The data container 208 according to the second protocol comprises the data unit 202-1.

According to a third protocol, the data container 210 comprises the data unit 203-1.

The data container 212 according to a fourth protocol comprises the two data units 204-1, 204-2.

The data unit segments are collected by the circuit 110 in the data containers. The order of the segments in the respective data unit in the containers is the same as the order that the segments have in the received data units. The order of the data units within a container is the same as the order in which the data units collected in the particular container are received.

According to the example shown in FIG. 2, the device comprises four transmitters, one for each of the four protocols. The four transmitters each provide a socket for one of the protocols. At least one of the four transmitters can provide a plurality of sockets, each with different attributes. For example, the transmitters support one of two protocols: Ethernet or CAN. A transmitter that supports Ethernet can have a plurality of sockets. Socket attributes for Ethernet are properties of the Ethernet stack: e.g. IP addresses, UDP port numbers. A transmitter that supports CAN can also have a plurality of sockets. Socket attributes for CAN are properties of the CAN stack: e.g. CAN ID.

The respective data units are assigned to the socket that is designed for the protocol according to which the particular data unit is formatted. The segments of a particular data unit are assigned to the socket that is designed for the protocol according to which the data unit is formatted.

The segments of a particular data unit are assigned to the data container for the protocol according to which the data unit containing the segments is formatted.

The segments belonging to data units, which are assigned to the same socket, are not reordered. The segments belonging to data units, which are assigned to different data containers, are not nested.

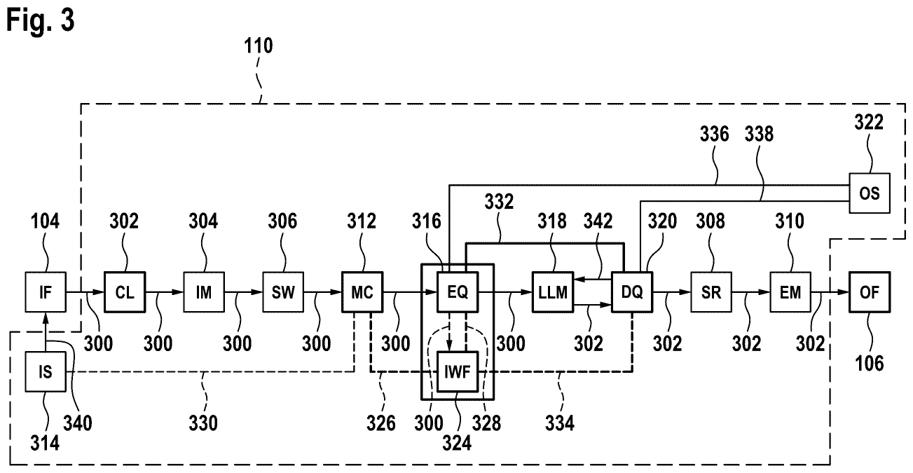

FIG. 3 schematically shows a part of the device 100 according to one example.

The circuit 110 comprises a data bus 300 for the segments of an incoming data unit. The segments of the incoming data unit in each case comprise a header and user data.

The circuit 110 comprises a classifier 302. The classifier 302 is designed to determine a class of the incoming data unit. The classifier 302 is designed to determine the class from a set of classes. The classes in the set of classes are in each case assigned to a data traffic queue for the class. Different queues are provided for different classes.

For example, the classifier 302 is designed to search in a received segment of the incoming data unit for a header that identifies the protocol according to which the incoming data packet is formatted. The header comprises, for example, an identifier of the protocol in which the incoming packet is formatted. For example, the classifier 302 is designed to classify the incoming data unit by looking up the class for the header content in a table that comprises an assignment of the identifier to the class. The header contains, for example, an identifier of the protocol according to which the incoming data unit is formatted, e.g. a CAN identifier or a LIN identifier.

The circuit 110 comprises an input modifier 304. The input modifier 304 is designed to modify the header of the segments of the incoming data unit in order to prepare the data units in each case for an output protocol. The output protocol is the protocol that is used to output the data unit. For example, input modifier 304 is designed to modify the header of the incoming data packet in order to specify the output protocol in the header.

The circuit 110 can comprise a segment writer 306. The segment writer 306 is designed to take the user data of the particular segment from the data bus and write the segment to a buffer.

The circuit 110 can comprise a segment reader 308. The segment reader 308 is designed to read the user data of the particular segment from the buffer and to insert the user data of the segment of the incoming data unit into a segment of an outgoing data unit of a data container on the data bus.

The outgoing data unit segment comprises the modified header of the incoming data unit segment and the user data of the incoming data unit segment.

The circuit 110 comprises an output modifier 310. The output modifier 310 is designed to prepare the data unit for the outgoing protocol. For example, output modifier 310 is designed to format the data unit according to the output protocol.

Between the segment writer 306 and the segment reader 308, the circuit 110 is designed to process metadata. This means that the user data are not processed by the circuit 110 after the segment writer, between the segment writer 306 and the segment reader 308.

The circuit 110 can comprise a multicasting device 312. The multicasting device 312 is designed to create a plurality of copies of the incoming data unit of the slot for one or more other slots. The copy, or copies, of the incoming data unit can be transmitted in different data containers, e.g. according to different protocols, e.g. CAN, LIN, Ethernet. The copy or copies of the metadata can be transmitted by different transmitters.

The circuit 110 is designed to process each copy separately for this purpose.

The multicasting device 312 is designed to provide slots for processing the data unit and the copy or copies. The multicasting device 312 is designed to process the incoming data unit with higher priority than a data unit that requires multicast if the incoming data unit does not require a multicast copy.

The circuit 110 can be designed to process the incoming data unit using a first-in-first-out method if the incoming data unit requires a multicast copy. The circuit 110 can be designed to process the incoming data unit by using a first-in-first-out method if the incoming data unit is intended for unicast. The circuit 110 can be designed to process the incoming data unit with a higher priority than a data unit for multicast if the incoming data unit is intended for unicast.

For example, the circuit 110 is designed to stop receiving segments through the input interface 104 upon recognizing that the fill level of the memory with segments to be routed has reached or exceeded a threshold value. For example, the circuit 110 is designed to start receiving segments through the input interface 104, upon recognizing that the fill level of the memory with segments to be routed is below a threshold value.

The device 110 comprises an input scheduler 314. The input scheduler 314 is designed to decide which data units from which input device are accepted by the input interface 104.

The fill level of the memory exceeds the threshold value, for example, if slots are required for copies, or if closing a data container is required, or if the memory does not have sufficient capacity to receive additional segments of data units from the slots that are already located in the pipeline from the input interface 104 to the multicasting device 312.

The circuit 110 comprises a queue engine 316. The queue engine 316 is designed to process the metadata of segments of data units. The queue engine 316 is designed to verify whether there is still space in the data traffic queues. The queue engine 316 is designed to delete one or more data units if there is no more space in the data traffic queues.

The device 110 comprises a link list manager 318.

The queue engine 316 is designed to output the processed metadata of segments to the link list manager 318. The link list manager 318 comprises at least one data traffic queue for a data unit scheduler 320.

The data unit scheduler 320 is designed to forward the metadata of segments of a full container if data units are multiplexed, or of a full data unit of the link list manager 318 to at least one data container.

The data unit scheduler 320 is designed to transmit the metadata of segments of the data units or the data unit of a closed data container to the segment reader 308.

The device 110 comprises an output scheduler 322. The output scheduler 322 is designed to transmit the segments of the data units of the closed data container to the output interface 106.

The output scheduler 322 is designed to recognize which of the transmitters is available to transmit a data container and to transmit the segments of the data units of the closed data container for which the transmitter is available to the output interface 106.

The circuit 110 comprises an interaction function 324.

The interaction function 324 comprises a first interface 326. The first interface 326 is designed to stall the pipeline. This prevents new segments from being transmitted to queue engine 316 during the next slot.

The interaction function 324 comprises a second interface 228. The interaction function 324 uses the second interface 228 to inform the queue engine 316 whether the processed segment will result in the closure of 0, 1 or 2 containers.

The input scheduler 314 and the multicasting device 312 are designed to communicate via a third interface 330 with regard to the starting or stopping of the reception of segments for processing. The multicasting device 312, for example, is designed to instruct the input scheduler 314 via the third interface 330 to begin receiving when it receives the instruction to start receiving from the interaction function 324. The multicasting device 312, for example, is designed to instruct the input scheduler 314 via the third interface 330 to stop receiving when it receives the instruction to stop receiving from the interaction function 324.

The queue engine 316 and the data unit scheduler 320 are designed to communicate via a fourth interface 332. For example, the queue engine 316 is designed to inform the data unit scheduler 320 via the fourth interface 332 that a new data unit is available for scheduling.

The interaction function 324 comprises a fifth interface 334. The fifth interface 334 is designed to specify which segment is the first segment of a container and which segment is the last segment of the container. The first segment of a container can be assigned an indication that indicates that the first segment is the first segment of the container. The last segment of the container can be assigned an indication that indicates that the last segment is the last segment of the container.

The queue engine 316 and the output scheduler 322 are designed to communicate via a sixth interface 336. The sixth interface 336 is used, for example, to announce that a new data unit is available for planning.

The data unit scheduler 320 is designed to schedule data traffic queues for a specific output device. The output scheduler 322 is designed to schedule output devices. The data unit scheduler 320 and the output scheduler 322 are designed to communicate via a seventh interface 338. The output scheduler 322 informs the data unit scheduler 320, for example via the seventh interface 338, in particular for each slot, for which output device a traffic queue is to be scheduled.

The input scheduler 314 and the input interface 104 are designed to communicate via an eighth interface 340. The input scheduler 314, for example, is designed to instruct the input interface 104 via the eighth interface 340 which input device is to be selected.

The data unit scheduler 320 and the link list manager 318 are designed to communicate via a ninth interface 342. For example, the data unit scheduler 320 requests a segment from the traffic queue, which was selected by the data unit scheduler 320, from the link list manager 318 via the ninth interface 342.

The interaction function 324 is designed to open the data container.

The interaction function 324 is designed to decide for the segments of the incoming data unit whether it is the first segment, the last segment, or neither of these, of a data container. The interaction function 324 is designed to collect the segments of the incoming data unit in the data container.

The interaction function 324 is designed to reserve bytes in the data container for protocol headers, for example, on the basis of the protocol identifier.

The interaction function 324 is designed, for example on the basis of the socket identifier, to recognize the socket to which the incoming data unit is assigned and to create the data container upon recognizing that the incoming data unit is assigned to the socket.

The input interface 104 can be designed to receive the segments of the incoming data unit in sequential order. The interaction function 324 can be designed to recognize the first segment in sequential order as the first segment of the data container.

The interaction function 324 can be designed to open the data container upon recognizing the first segment.

For example, the queue engine 316 is designed to allocate memory 120 for a segment if it pushes the segment into a data traffic queue.

The interaction function 324 is designed to close the data container.

The interaction function 324 can be designed to recognize the last segment in sequential order as the last segment of the data container.

The interaction function 324 can be designed to recognize that a condition for closing the data container is met.

The interaction function 324 can be designed to determine the number of bytes accumulated in the data container. The interaction function 324 can be designed to recognize that the condition for closing the first data container is met if the number of bytes reaches or exceeds a specified number of bytes. The interaction function 324 can be designed to recognize that the condition for closing the first data container is met, taking into account the data integrity of the last data unit.

The interaction function 324 can be designed to exclude the incoming data unit from the data container upon recognizing that the condition for closing the data container is met.

According to one example, there is a maximum number of bytes for each socket. The interaction function 324 is designed to close the container with the previous data units and open a new container with the last data unit if a data unit does not fit, i.e. exceeds the maximum number of available bytes.

The interaction function 324 can be designed to recognize that the condition for closing the data container is met upon receiving a segment of the incoming data unit, wherein the incoming data unit is a data unit that triggers the closing.

The interaction function 324 can be designed to determine whether or not the segment is the last segment of the incoming data unit, to wait until the last segment of the incoming data unit is received, and to recognize that the condition for closing the data container is met when the last segment of the incoming data unit is received.

The interaction function 324 can be designed to start a time or cycle counter upon opening the data container. The interaction function 324 can be designed to recognize that the condition for closing the data container is met if the counter exceeds a limit value.

The interaction function 324 can be designed to recognize that segments of the incoming data unit are missing in the data container, to wait until the data container is holding the last segment of the incoming data unit, and to recognize that the condition for closing is met, upon recognizing that the data container is holding the last segment of the incoming data unit.

The interaction function 324 can be designed to recognize an error in a segment of the incoming data unit and to remove the incoming data unit from the data container upon recognizing the error.

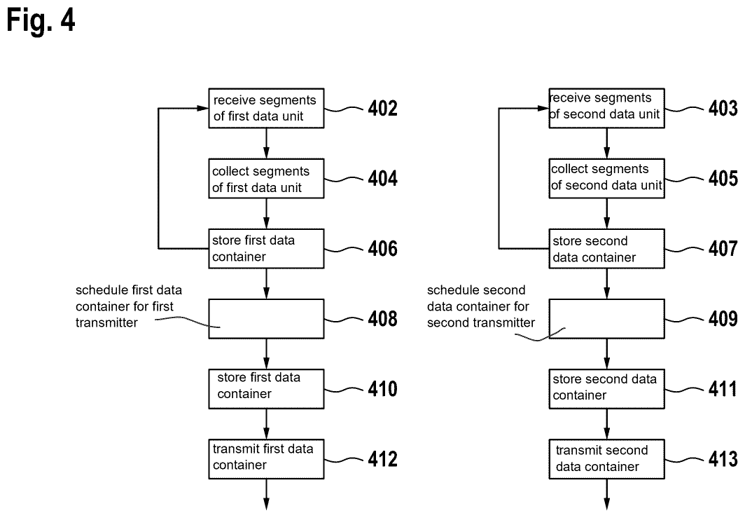

FIG. 4 is a flowchart that comprises steps of a method for processing the data units 102. The method is described taking the example of two incoming data units, a first data unit and a second data unit. The data units are formatted according to different protocols. The first data unit is, for example, formatted according to a first protocol, e.g. the LIN protocol. The second data unit is, for example, formatted according to a second protocol, e.g. the CAN protocol. The method is not limited to processing two data units. The method is not limited to processing two different protocols.

The method comprises a step 402.

The step 402 comprises receiving segments of the first data unit via the input interface 104.

The method comprises a step 403.

The step 403 comprises receiving segments from the second data unit via the input interface 104.

The method comprises a step 404.

The step 404 comprises collecting segments of the first data unit using the circuit 110 in the first data container.

The step 404, for example, comprises routing the segments of the first data unit to a first traffic queue by using the circuit 110. The first traffic queue is assigned to a first socket.

The method comprises a step 405.

The step 405 comprises collecting the segments of the second data unit by using the circuit 110 in the second data container.

The step 405, for example, comprises routing the segments of the second data unit by using the circuit 110 to a second traffic queue. The second traffic queue is assigned to a second socket.

The method comprises a step 406.

The step 406 comprises storing the first data container by using the circuit 110 in the memory 120.

The method comprises a step 407.

The step 407 comprises storing the second data container by using the circuit 110 in the memory 120.

The steps 402, 404, and 406 are repeated, for example, to collect other segments in the first data container, in particular to route segments of data units to the first socket until the condition for closing the first container is met.

The steps 403, 405, and 407 of the method are repeated, for example, in order to collect other segments in the second data container, in particular to route segments of data units to the second socket until the condition for closing the second container is met.

The method comprises a step 408. The step 408, for example, is executed upon recognizing that the first data container is closed.

The step 408 comprises scheduling the first data container for the first transmitter 112 by using the scheduler 322.

The method comprises a step 409. The step 409, for example, is executed upon recognizing that the second data container is closed.

The step 409 comprises scheduling the second data container for the second transmitter 112 by using the scheduler 322.

Segments of one data container for one transmitter can be nested with segments of a data container for another transmitter. If the two transmitters are the same, the segments will not be nested.

The method can comprise nesting segments of containers that are scheduled for different transmitters. The method can comprise non-nesting of container segments that are scheduled for the same transmitter.

The method comprises a step 410.

The step 410 comprises transmitting the first data container by using the output interface 106.

The first transmitter 112 stores the first data container in the memory 122.

The method comprises a step 411.

The step 411 comprises transmitting the second data container via output interface 106.

The second transmitter 116 stores the second data container in the memory 124.

The method comprises a step 412.

The step 412 comprises transmitting the first data container by using the first transmitter 112.

The method comprises a step 413.

The step 413 comprises transmitting the second data container by using the second transmitter 116.

The steps of the method can be repeated to process further data units, in particular to route further data units to different sockets.

The circuit 110, which comprises the interaction function 324, is one example. The circuit 110 can comprise state machines.

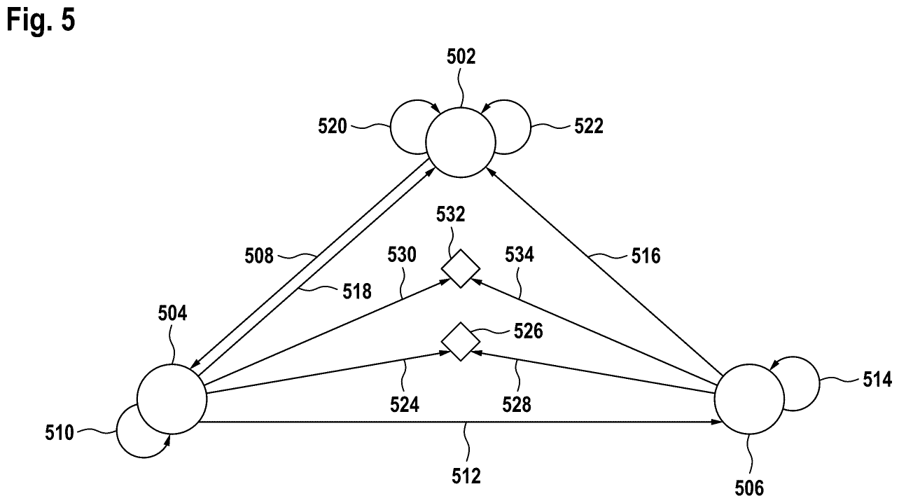

FIG. 5 shows a state machine for the segment processing of segments of the incoming data unit.

The state machine for segment processing comprises a first state 502, a second state 504 and a third state 506.

In the first state 502, segment processing is idle.

In the second state 504, segment processing collects segments for the data container.

In the third state 506, segment processing continues to collect segments and before closing the container waits until it has processed the last segment of the current data unit.

According to a first transition 508, segment processing switches from the first state 502 to the second state 504 if no error is detected and the data container is open.

The first transition 508 starts the timer.

According to a second transition 510, segment processing remains in the second state 504 if no error is detected, no overflow is detected, and the data container is not closed.

According to a third transition 512, segment processing switches from the second state 504 to the third state 506 if no error is detected, no overflow is detected, the data container is closed, and segments of the data unit are still to be processed.

According to a fourth transition 514, segment processing remains in the third state 506 if no error is detected, no overflow is detected, and segments of the data unit are still to be processed, in particular due to data integrity.

According to a fifth transition 516, segment processing switches from the third state 506 to the first state 502 if no error is detected, no overflow is detected, and all segments of the data unit have been processed.

The fifth transition 516 stops the timer.

The fifth transition 516 triggers the detection of the last segment of the data container.

According to a sixth transition 518, segment processing switches from the second state 504 to the first state 502 if no error is detected, no overflow is detected, the container is closed, and all segments of the incoming data unit have been processed.

The sixth transition 518 stops the timer.

The sixth transition 518 triggers the detection of the last segment of the data container.

According to a seventh transition 520, segment processing remains in the first state 502 if no error is detected.

The seventh transition 520 simultaneously triggers the detection of the first segment of the data container and the last segment of the data container.

According to an eighth transition 522, segment processing remains in the first state 502 if an error is detected.

According to a ninth transition 524, segment processing switches from the second state 504 to overflow handling 526 if no error is detected and an overflow is detected.

The ninth transition 524 stops the timer and removes the current data unit from the data container.

According to a tenth transition 528, segment processing switches from the third state 506 to overflow handling 526 if no error is detected and an overflow is detected.

The tenth transition 528 stops the timer and removes the current data unit from the data container.

According to an eleventh transition 530, segment processing switches from the second state 504 to error handling 532 if an error is detected.

According to a twelfth transition 534, segment processing switches from the third state 506 to error handling 532 if an error is detected.

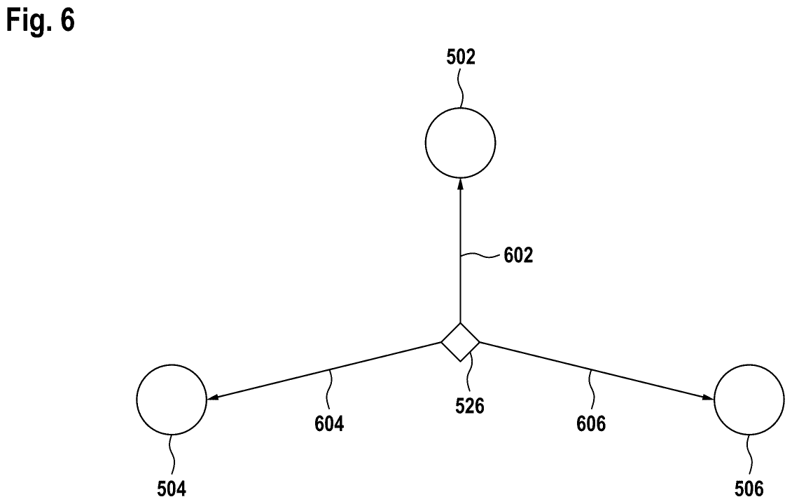

FIG. 6 shows a state machine for overflow handling 526.

The overflow handling 526 comprises a first transition 602 to the first state 502 if the current data container is closed and all segments of the incoming data unit have been processed. The first transition 602 of the overflow handling 526 triggers the detection of the last segment of the current data container and the last segment of the previous data container.

The overflow handling 526 comprises a second transition 604 to the second state 504 if the current data container remains open. The second transition 604 of the overflow handling 526 triggers the detection of the last segment of the previous data container. The second transition 604 of the overflow treatment 526 starts the timer.

The overflow handling 526 comprises a third transition 606 to the third state 506 if the current data container is closed and segments of the incoming data unit are still to be processed. The third transition 606 of the overflow handling 526 triggers the detection of the last segment of the previous data container. The third transition 606 of the overflow treatment 526 starts the timer.

The overflow is recognized, for example, if the fill level of the data container reaches or exceeds a second threshold value. According to one example, otherwise no overflow will be detected. According to one example, the first threshold value is lower than the second threshold value.

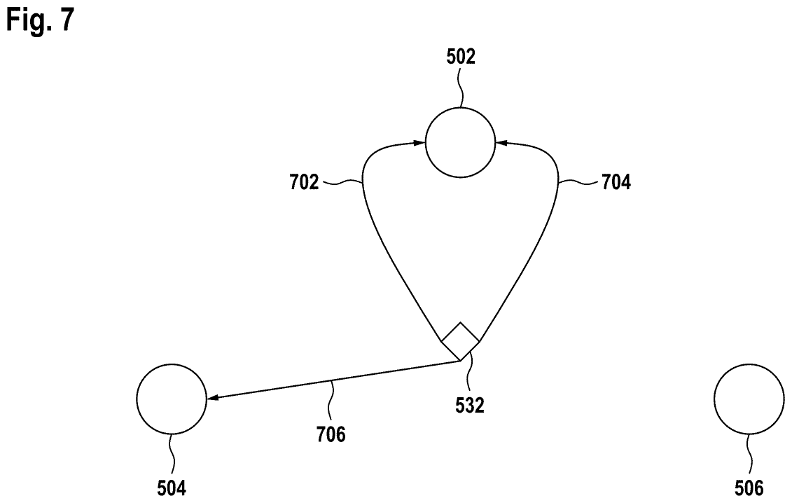

FIG. 7 shows a state machine for error handling 532.

The error handling 532 comprises a first transition 702 to the first state 502 if the incoming data unit is the first data unit for the data container. The first transition 702 of the error handling 532 stops the timer.

The error handling 532 comprises a second transition 704 to the first state 502 if the incoming data unit is not the first data unit for the data container and the timer is idle. The second transition 704 of the error handling 532 triggers the detection of the last segment of the incoming data unit.

The error handling 532 comprises a third transition 706 to the second state 504 if the incoming data unit is not the first data unit for the data container and the timer is not idle.

The error is detected, for example, if an error is found in a segment of the incoming data unit. According to one example, otherwise no error will be detected.

Error handling 532 comprises removing the incoming data unit from the data container upon detection of the error.

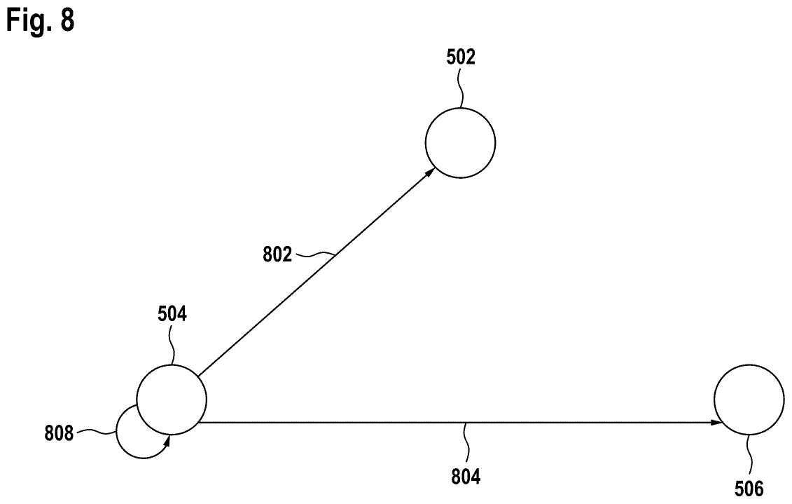

FIG. 8 shows a state machine for time processing.

The time processing comprises a first transition 802 from the second state 504 to the first state 502 if a timeout is detected and all segments of the incoming data unit have been processed. The first transition 802 of the time processing stops the timer. The first transition 802 of the time processing triggers the detection of the last segment of the data container.

The time processing comprises a second transition 804 from the second state 504 to the third state 506 if a timeout is detected and segments of the incoming data unit still need to be processed. The second transition 804 of the time processing stops the timer.

The time processing comprises a third transition 808 from the second state 504 to the second state 504 if no timeout is detected.

The timeout is detected, for example, if the timer exceeds the limit value. The limit value is specific to each socket. According to one example, otherwise no timeout will be detected.

1-15. (canceled)

16. A device configure to process data units, comprising:
an input interface configured to receive segments of a first data unit;
an output interface configured to transmit a first data container;
a circuit configured to collect the segments of the first data unit in the first data container; and
a first transmitter configured to receiving the first data container from the output interface and to transmit the first data container;
wherein:
the circuit includes a memory, wherein the circuit is configured to store the first data container in the memory of the circuit,
the first transmitter includes a memory for storing the first data container,
the input interface is configured to receive segments of a second data unit,
the output interface is configured to transmit a second data container,
the circuit is configured to collect the segments of the second data unit in the second data container,
the device further comprises a second transmitter configured to receive the second data container from the output interface and to transmit the second data container,
the circuit is configured to store the second data container in the memory of the circuit, and
the second transmitter includes a memory for storing the second data container.

17. The device according to claim 16, wherein the device is configured to process data units in an automotive network.

18. The device according to claim 16, wherein: (i) the first data unit is formatted according to a first protocol, the circuit being configured to recognize that the segments of the first data unit are formatted according to the first protocol, and to collect the segments of the first data unit in the first data container upon recognizing that the segments of the first data unit are formatted according to the first protocol, and/or (ii) the second data unit is formatted according to a second protocol, the circuit being configured to recognize that the segments of the second data unit are formatted according to the second protocol, and to collect the segments in the second data unit in the second data container upon recognizing that the segments of the second data unit are formatted according to the second protocol.

19. The device according to claim 16, wherein the first transmitter is configured to provide a first socket for transmitting the first data container, wherein the first data unit is assigned to the first socket, wherein the circuit is configured to detect that the first data unit is assigned to the first socket and, upon detecting that the first data unit is assigned to the first socket, to schedule the first data container for the first socket.

20. The device according to claim 16, wherein the input interface is configured to receive the segments of the first data unit in sequential order, wherein the circuit is configured to recognize a first segment in sequential order as a first segment of the first data container, to allocate the memory for the first data container segment by segment in the memory of the circuit upon recognizing the first segment, and to store the first segment as the first segment of the first data container in the memory of the circuit.

21. The device according to claim 16, wherein the input interface is configured to receive the segments of the first data unit in sequential order, wherein the circuit is configured to recognize a last segment in sequential order as a last segment of the first data container, and upon recognizing the last segment, to store the last segment as the last segment of the first data container in the memory of the circuit: to schedule the first data container for the first transmitter and to release memory for the first data container in the memory of the circuit.

22. The device according to claim 16, wherein the circuit is configured to recognize that a condition for closing the first data container is met, and upon recognizing that the condition for closing the first data container is met, to schedule the first data container for the first transmitter and to release memory for the first data container in the memory of the circuit.

23. The device according to claim 22, wherein the circuit is configured to determine a quantity of bytes accumulated in the first data container and to recognize that the condition for closing the first data container is met when the quantity of bytes reaches or exceeds a specified quantity of bytes.

24. The device according to claim 23, wherein the circuit is configured to collect data units including a first data unit in the first data container, to exclude a last of the collected data units from the first data container upon recognizing that the condition for closing the first data container is met, and the last of the collected data units does not fit into the first data container, to open another data container for the first transmitter, and to store the data unit excluded from the first data container in the other data container.

25. The device according to claim 22, wherein the circuit is configured to recognize that the condition for closing the first data container is met upon receiving a segment of a data unit, wherein the data unit is a data unit that triggers the closing.

26. The device according to claim 25, wherein the circuit is configured to determine whether or not the segment is a last segment of the first data unit, and to wait until the last segment of the first data unit is received, and to recognize that the condition for closing the first data container is met upon receiving the last segment of the first data unit.

27. The device according to claim 22, wherein the circuit is configured to start a time or cycle counter upon opening the first data container, and to recognize that the condition for closing the first data container is met when the counter exceeds a limit value.

28. The device according to claim 22, wherein: (i) the circuit is configured to wait until the first data container includes a last segment of a last data unit for the first data container, and to recognize that the condition for closing is met upon recognizing that the first data container includes the last segment of the last data unit, or (ii) the circuit is configured to wait until the first data container includes the last segment of the last data unit, and to recognize a first segment of a next data unit, and to remove segments of the last data unit from the first data container.

29. The device according to claim 16, wherein the circuit is configured to detect an error in a segment of the first data unit and to remove the first data unit from the first data container upon detecting the error.

30. A method for processing data units, comprising:
receiving segments of a first data unit using an input interface;
transmitting a first data container using an output interface;
collecting the segments of the first data unit in the first data container using a circuit;
receiving the first data container from the output interface by a first transmitter;
transmitting the first data container using the first transmitter;
wherein the circuit includes a memory;
storing the first data container using the circuit in the memory of the circuit;
wherein the first transmitter includes a memory for storing the first data container;
receiving segments of a second data unit with the input interface;
transmitting a second data container to the output interface;
collecting the segments of the second data unit using the circuit in the second data container;
receiving the second data container from the output interface by a second transmitter;
transmitting the second data container using the second transmitter;
scheduling the second data container for the second transmitter with the scheduler;
storing the second data container using the circuit in the memory of the circuit;
wherein the second transmitter includes a memory for storing the second data container.

31. The method according to claim 30, wherein the processing of the data units is in an automotive network.

32. The method according to claim 30, further comprising collecting the first data unit and at least one further data unit in the first data container and/or collecting the second data unit and at least one further data unit in the second data container.
